(19) United States
(12) Patent Application Publication
(10) Pub. No.: US 2021/0238007 A1
(43) Pub. Date: Aug. 5, 2021

(54) CABLE REEL WITH AUTOMATED CONNECTION

(71) Applicant: ChargePoint, Inc., Campbell, CA (US)

(72) Inventors: Jonathan Christopher Wilson, San Jose, CA (US); Duane Leigh Gilbert, JR., Sunnyvale, CA (US); Damian Matthews, Aptos, CA (US); David Baxter, Monte Sereno, CA (US)

(21) Appl. No.: 17/164,346

(22) Filed: Feb. 1, 2021

Related U.S. Application Data
(60) Provisional application No. 62/704,070, filed on Jan. 31, 2020.

(51) Int. Cl. B65H 75/44

(52) U.S. Cl. CPC B65H 75/4484; B65H 75/4486

(57) ABSTRACT

A cable reel includes a spool to extend and retract a cable that includes a first conductor. The cable reel further includes a first connector that is connected with the spool and rotates in relation to the spool. The first connector includes a first contact that is connected to the first conductor of the cable. The cable reel further includes a second connector that does not rotate. The first connector and the second connector are mateable. The second connector includes a second contact that is connected to a second conductor. The first connector and the second connector automatically mate to make an electrical connection between the first conductor of the cable and the second conductor when the first connector and the second connector are aligned in a predetermined position and at least some length of cable has been extended.

### CROSS-REFERENCE TO RELATED APPLICATIONS

This application claims the benefit of U.S. Provisional Application No. 62/704,070, filed Jan. 31, 2020, which is hereby incorporated by reference.

### FIELD

Embodiments of the invention relate to the field of cable reels; and more specifically, to a cable reel with automated connection.

### BACKGROUND

Cable reels are common to wind and unwind cable. Some cables include electrical connections that carry power and/or data. In many cases, it is desirable to separate a rotating portion of the electrical connection with the stationary portion of the electrical connection. A slip ring may be used to maintain continuity of the electrical connection between the rotating portion with the stationary portion. In a slip ring, the stationary portion of the electrical connection includes a metal contact (often referred to as a brush) that constantly rubs on a rotating metal ring that is electrically connected with rotating portion. The power and/or signal is conducted through the stationary metal contact and the rotating metal ring. Each electrical contact requires its own brush and rings. The brushes and contacts care subject to wearing out.

### SUMMARY

A cable reel includes a spool that rotates to extend and retract a cable that includes a first electrical conductor. The cable reel further includes a first connector that is connected with the spool and rotates in relation to the spool. The first connector includes a first contact that is connected to the first electrical conductor of the cable. The cable reel further includes a second connector that does not rotate. The first connector and the second connector are mateable. The second connector includes a second contact that is connected to a second electrical conductor. The first connector and the second connector automatically mate to make an electrical connection between the first electrical conductor of the cable and the second electrical conductor when the first connector and the second connector are aligned in a predetermined position and at least some length of cable has been extended. In an embodiment, the at least some length of the cable has been extended is a fully extended cable. In an embodiment, the second connector is at a first position when unmated with the first connector and moves axially to a second position when mated with the first connector. The first connector and the second connector automatically unmate to break the electrical connection between the first electrical conductor of the cable and the second electrical conductor when the cable is retracted.

An embodiment describes a system for electric vehicle charging that uses the cable reel. The system includes an electric vehicle supply equipment (EVSE) and a cable reel. The cable reel includes a spool that rotates to extend and retract a cable that includes a first electrical conductor. The cable reel further includes a first connector that is connected with the spool and rotates in relation to the spool. The first connector includes a first contact that is connected to the first electrical conductor of the cable. The cable reel further includes a second connector that does not rotate. The first connector and the second connector are mateable. The second connector includes a second contact that is connected to a second electrical conductor. The first connector and the second connector automatically mate to make an electrical connection between the first electrical conductor of the cable and the second electrical conductor when the first connector and the second connector are aligned in a predetermined position and at least some length of cable has been extended. In an embodiment, the at least some length of the cable has been extended is a fully extended cable. In an embodiment, the second connector is at a first position when unmated with the first connector and moves axially to a second position when mated with the first connector. The first connector and the second connector automatically unmate to break the electrical connection between the first electrical conductor of the cable and the second electrical conductor when the cable is retracted

### BRIEF DESCRIPTION OF THE DRAWINGS

The invention may best be understood by referring to the following description and accompanying drawings that are used to illustrate embodiments of the invention. In the drawings:

FIG. 1 illustrates a front perspective view of the improved cable reel according to an embodiment.

FIG. 2 illustrates a front view of the improved cable reel according to an embodiment.

FIG. 3 shows a view of the cable reel where the cable is partially extended from the cable reel.

FIG. 4 shows a view of the cable reel where the cable is fully extended from the cable reel.

FIG. 5 shows a side view of the cable reel without showing the cables according to an embodiment.

FIG. 6 shows the side view of the cable reel without showing the cables and a hanger component according to an embodiment.

FIG. 7 shows a side view of the cable reel without showing the full length of the cable according to an embodiment.

FIG. 8 shows the side view of the cable reel without showing the full length of the cable and without showing the hanger component according to an embodiment.

FIG. 9 shows a front view of the cable reel without showing the cables according to an embodiment.

FIG. 10 shows a rear view of the cable reel without showing the cables according to an embodiment.

FIG. 11 shows a front view of the cable reel without showing the spool and the cables according to an embodiment.

FIG. 12 shows a front perspective view of the cable reel without showing the spool and the cables according to an embodiment.

FIG. 13 shows a front perspective of the cable reel that shows the position of the rotating connector when the spool has completed approximately one-quarter of a full revolution according to an embodiment.

FIG. 14 shows a front perspective of the cable reel that shows the position of the rotating connector when the spool has completed approximately one-half of a full revolution according to an embodiment.

FIG. 15 shows a rear perspective of the cable reel that shows the position of the rotating connector when the spool has completed approximately three-quarter of a full revolution according to an embodiment.

FIG. 16 illustrates the cable reel where the solenoid plungers are extended according to an embodiment.

FIG. 17 shows a front view of the cable reel without showing the spool and cables where the solenoid plungers are extended according to an embodiment.

FIG. 18 is a flow diagram that illustrates exemplary operations for the cable reel described herein according to an embodiment.

### DESCRIPTION OF EMBODIMENTS

An improved cable reel with automated connection is described. The cable reel includes a spool that unwinds (extends) and winds (retracts) a cable. The cable includes at least one electrical conductor for carrying power and/or data. The cable reel includes a first connector that is connected with the spool and rotates in relation to the spool. The first connector includes at least one contact that is connected to the at least one electrical conductor of the cable. The cable reel includes a second connector that does not rotate and includes at least one contact that is connected to at least one electrical conductor of a non-rotating object. The first connector and the second connector are mateable. The first connector and the second connector may not be mated when the cable is fully wound on the spool and/or the cable reel is not in use. The cable reel automatically mates the first connector and the second connector to make an electrical connection between the at least one electrical conductor of the cable and the at least one electrical conductor of the non-rotating object when the first connector and the second connector are aligned and at least some of the cable has been extended from the spool. The first connector and the second connector do not mate when the spool is rotating. Thus, the contacts are not in continuous contact when the spool is rotating. In a specific embodiment, the automatic mating occurs when the complete payload of cable has been extended from the spool. The cable reel automatically unmates the first connector and the second connector to break the electrical connection between the at least one electrical conductor of the cable and the at least one contact when the cable is retracted.

In an embodiment, the second connector is at a first position when unmated with the first connector and moves axially to a second position to mate with the first connector. In an embodiment, the cable reel includes one or more solenoids to cause the first connector and the second connector to mate and unmate. For instance, the solenoid(s) may cause axial movement that mates and unmates the first connector and second connector. The solenoid(s) may be under control by a software controlled control board included in the cable reel or a software control controlled board in an external device.

The improved cable reel may include a motor (e.g., a DC motor, an AC motor, a stepper motor, a brushed motor, a brushless motor, a hydraulic motor, a pneumatic motor, a linear motor, etc.) that assists in winding and/or unwinding the cable. The motor may include an encoder that can be used for determining the current position of the spool (e.g., the number of revolutions) and therefore the length of cable that is extended from the spool. Instead of an integrated encoder, an external encoder (e.g., a quadrature encoder) or sensor (e.g., an optical sensor) may be used to determine the current position of the spool. Upon a predetermined length of cable being extended through assistance of the motor as determined by the position of the spool, the solenoid(s) plunger(s) may extend to cause the first connector and the second connector to mate. The predetermined length of cable may be chosen such that the first connector and the second connector are aligned in a mateable position when the predetermined length of cable has been extended. In a specific embodiment, the predetermined length of cable corresponds to the cable being fully extended from the cable reel. Prior to the cable winding (e.g., prior to the motor winding/retracting the cable), the solenoid(s) may cause axial movement that unmates the first connector and the second connector (e.g., the solenoid(s) plunger(s) may retract to cause the first connector and the second connector to unmate). The electric motor may receive its power through a source external to the cable.

The operation of the motor may be controlled in different ways in different embodiments. In an embodiment, a controller that is physically or wirelessly connected to the cable reel controls the motor including causing it to wind and/or unwind the cable. The controller may include one or more physical buttons or switches for winding and/or unwinding the cable. In another embodiment, the motor is controlled through network communication (e.g., a processor included in the cable reel may receive and process a command to wind, unwind, and/or stop the winding/unwinding of the cable). The network communication may be received through a personal area network (e.g., Bluetooth, Zigbee), local area network, or a wide area network. By way of example, an application on a mobile device (e.g., a smartphone, a tablet, etc.) or a web application available on the internet may receive input to wind, unwind, and/or stop the winding/unwinding of the cable and a corresponding command may be sent to the processor included in the cable reel. In another embodiment, a camera or other detector may detect an object (e.g., an electric vehicle, a hand gesture) and automatically start extending the cable.

The improved cable reel design is more compact in the axial dimension than conventional cable reels that use slip ring connections. For instance, the size of conventional cable reels that use slip rings depends in part on the number of contacts (each contact has a separate contact ring) and the voltage supported by the slip ring. As a result, for some applications, a conventional cable ring that uses a slip ring can be large. However, since the improved cable reel design does not use contact rings like a slip ring, the size of the cable reel described herein is not as dependent on the number of contacts of the application. This allows the improved cable reel design to be more compact than conventional cable reels.

Unlike conventional cable reel designs that use slip rings that require continuous contact, the connector contacts in the improved cable reel design described herein are not in continuous contact when the spool is rotating. This improves reliability of the contacts because the reduced wear on the contacts as compared to a slip ring design. Further, if the cable is carrying power, the improved cable reel described herein is safer since power can only flow through the cable after the first connector and the second connector have been mated.

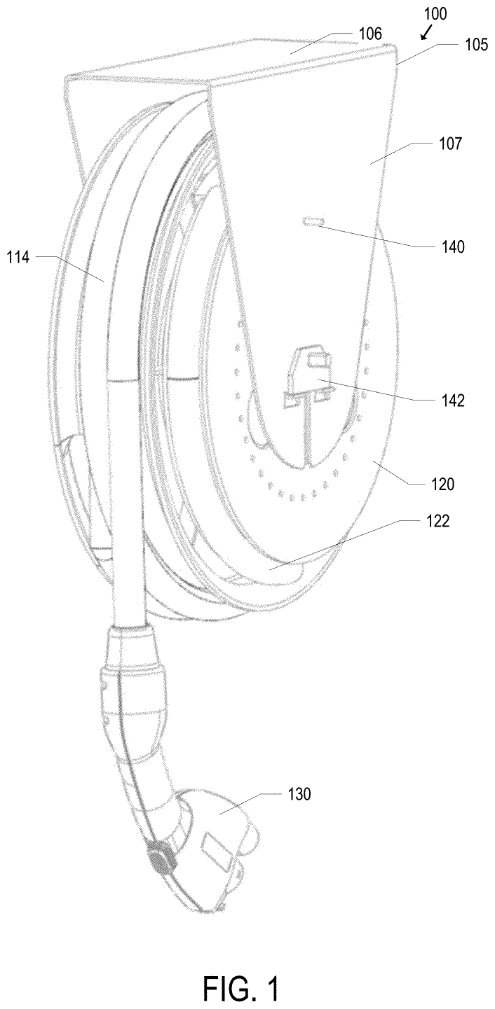

FIGS. 1-17 illustrate an embodiment of an improved cable reel 100. The cable reel 100 can be used in connection with an electric vehicle supply equipment (EVSE) for charging electric vehicle. For example, the cable reel 100 can be used to wind and unwind a charging cable that carries power and/or data between an EVSE and an electric vehicle. However, as previously described, a similar improved cable reel can be used in environments other than charging electric vehicles. Example environments include port crane power cable reels, mining power reels, extension cord reel, tethered robotic systems and drones for power and data, vacuum cleaner reels, fluid based systems such as a collapsible hose for example in which a fluid connection is made or broken only when extended, or any kind of power/data cord reel.

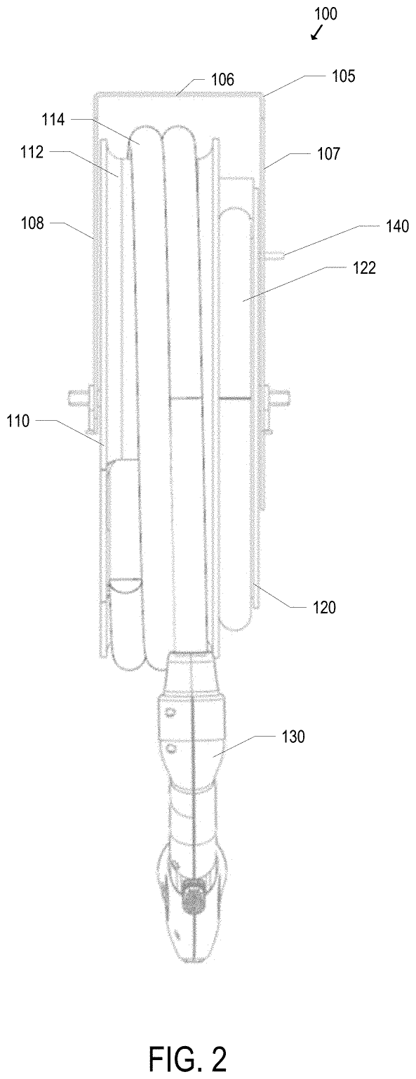

FIG. 1 illustrates a front perspective view of the improved cable reel according to an embodiment and FIG. 2 illustrates a front view of the improved cable reel of FIG. 1. The cable reel 100 includes a rotational side 110 and a rotationally fixed side 120. The rotational side 110 includes a spool 112 that unwinds (extends) and winds (retracts) a cable 114. The winding and unwinding of the cable 114 may be assisted or controlled by a motor 150 included within the cable reel 100. As shown in FIGS. 1 and 2, the cable 114 is wound around the spool 112. The cable 114 includes one or more electrical conductors and terminates at a distal end with a cable connector 130. The electrical conductor(s) may include one or more power wires and/or signal wires. The type of cable 114 and the type of cable connector 130 may be different depending on the environment in which the cable reel 100 is used. For instance, the cable 114 may be a charging cable for charging an electric vehicle and the cable connector 130 may connect to an inlet of an electric vehicle. The one or more electrical conductors of the cable 114 also terminates at a proximal end at a rotating connector 116, which is shown in later figures. The rotating connector 116 rotates in relation to the spool 112. The one or more electrical conductors of the cable 114 may be connected to one or more contacts of the rotating connector 116 using lugs, crimps, solder, or other ways of connection.

The rotationally fixed side 120 of the cable reel 100 is rotationally fixed (i.e., it does not rotate) and axially movable. The rotationally fixed side 120 includes a rotationally fixed connector 124 that does not rotate. The rotationally fixed connector 124 includes one or more contacts that are connected to a non-rotating object (the non-rotating cable 122). The non-rotating cable 122 does not wind around the rotating spool 112. The non-rotating cable 122 may be stationary. The non-rotating cable 122 includes one or more electrical conductors (e.g., one or more power wires and/or signal wires) that terminate at a distal end to another electrical source and terminate at a proximal end at one or more contacts at the rotationally fixed connector 124. In the example of the cable reel 100, the non-rotating cable 122 may be connected to an EVSE (not shown).

The rotating connector 116 and the rotationally fixed connector 124 are mateable and, when mated, provide an electrical connection between the conductor(s) of the cable 114 and the conductor(s) of the non-rotating cable 122. As will be shown in greater detail later herein, in an embodiment the conductor(s) of the cable 114 and the conductor(s) of the non-rotating cable 122 are not electrically connected when the cable 114 is wound around the spool 112. Also, in an embodiment, the conductor(s) of the cable 114 and the conductor(s) of the non-rotating cable 122 are not electrically connected with the spool 112 is being rotated. Instead, the conductor(s) of the cable 114 and the conductor(s) of the non-rotating cable 122 may electrically connect when the rotating connector 116 and the rotationally fixed connector 124 are in a predetermined position (e.g., aligned in a way that mating is possible) and at least some of the cable 114 has been extended from the cable reel 100.

The cable reel 100 includes the hanger 105 that, among other things, allows the cable reel 100 to be mounted for an overhead installation. The hanger 105 includes a top member 106, a side member 107, and a side member 108. The hanger 105 partially encloses the cable reel 100. The side member 107 is positioned near the fixed side 120 and the side member 108 is positioned near the rotational side 110 of the cable reel 100. The side member 107 and the side member 108 of the hanger 105 is secured with the rotationally fixed side 120 and the rotational side 110 of the cable reel 100 such as through brackets such as the brackets 142 and 143. The hanger 105 is rigid and may be made out of metal (e.g., sheet metal), rigid plastic, or other rigid material.

A set pin 140 extends from the rotationally fixed side 120 of the cable reel 100 through the hanger 105 that fixes the output position of the cable reel 100. The set pin 140 prevents the rotationally fixed side 120 of the cable reel 100 from rotating while also allowing the rotationally fixed side 120 to axially move. The set pin 140 can be inserted into one of 36 holes 144 (any position within 360 degrees at 10-degree increments).

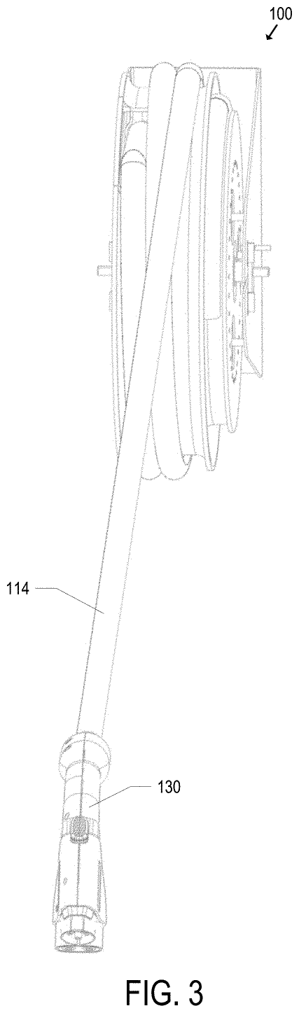

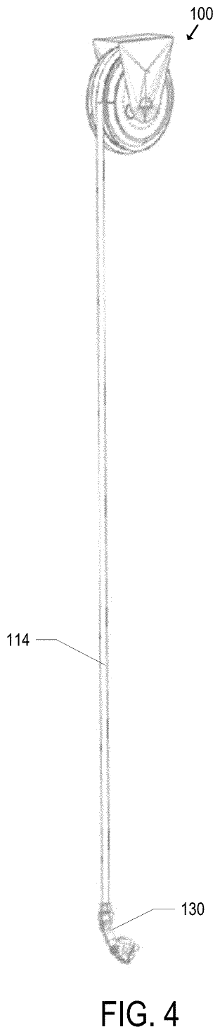

FIG. 3 shows a view of the cable reel 100 where the cable 114 is partially extended from the cable reel 100 (e.g., the spool has rotated one full revolution). FIG. 4 shows a view of the cable reel 100 where the cable 114 is fully extended from the cable reel 100.

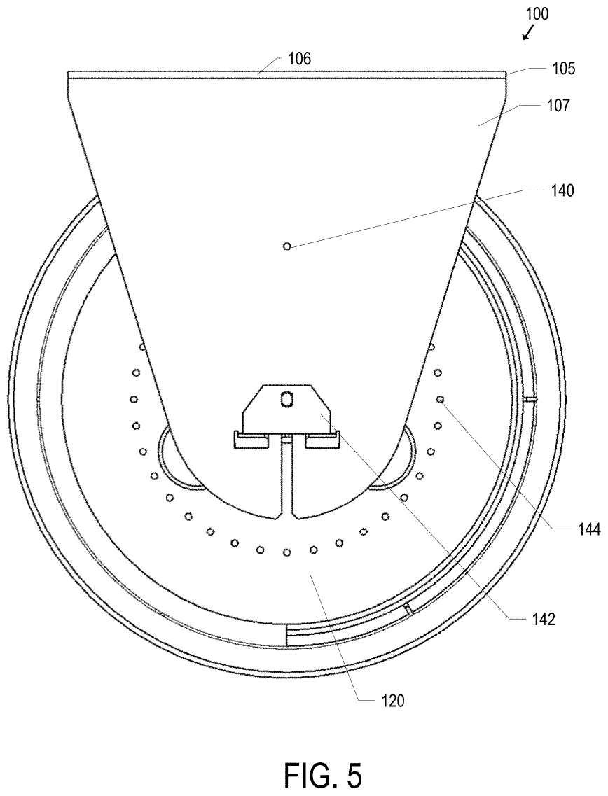

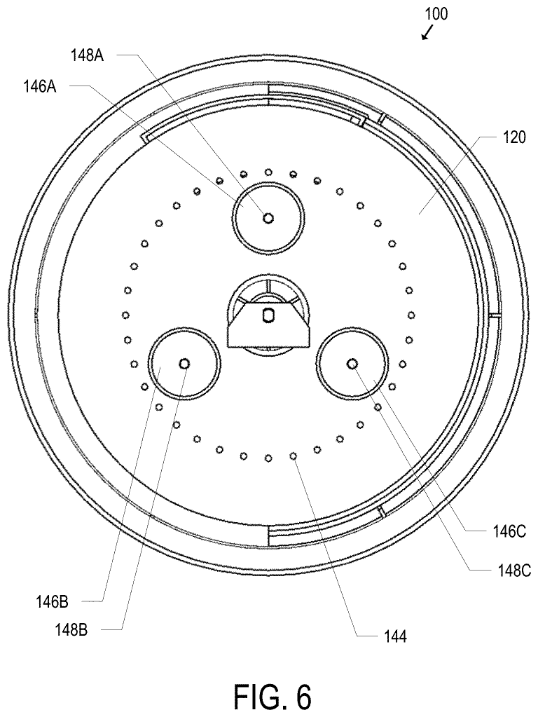

FIG. 5 shows a side view of the cable reel of FIG. 1 without showing the cables and FIG. 6 shows the side view of the cable reel 100 without showing the hanger 105. The views of FIGS. 5 and 6 show the rotationally fixed side 120 of the cable reel 100. The rotationally fixed side 120 is rotationally fixed and axially movable. The solenoids 146A-C control axial movement of the rotationally fixed side 120 of the cable reel 100 including the rotationally fixed connector 124. The solenoids 146A-C include the plungers 148A-C respectively. Although three solenoids are illustrated, in some embodiments fewer or more solenoids (e.g., one or more solenoids) may be used to control axial movement of the rotationally fixed side 120 of the cable reel 100. The solenoids 146A-C may be latching solenoids.

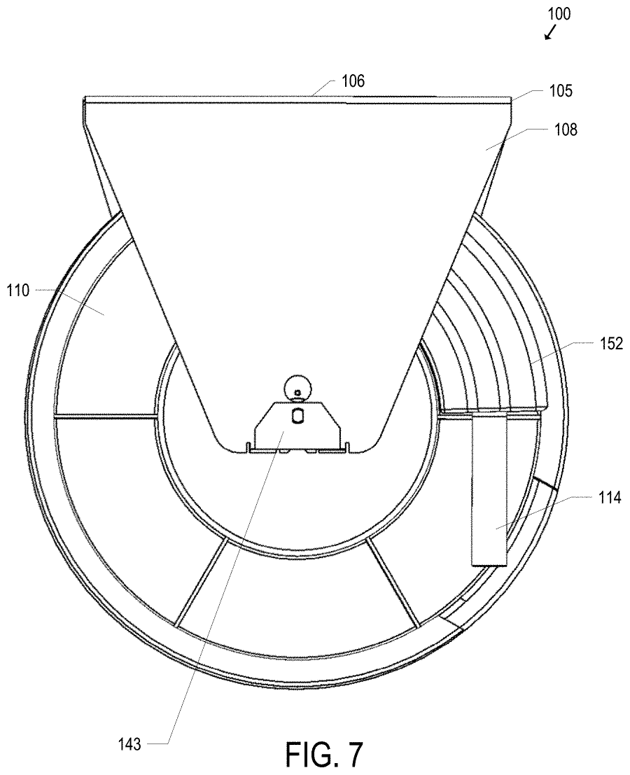

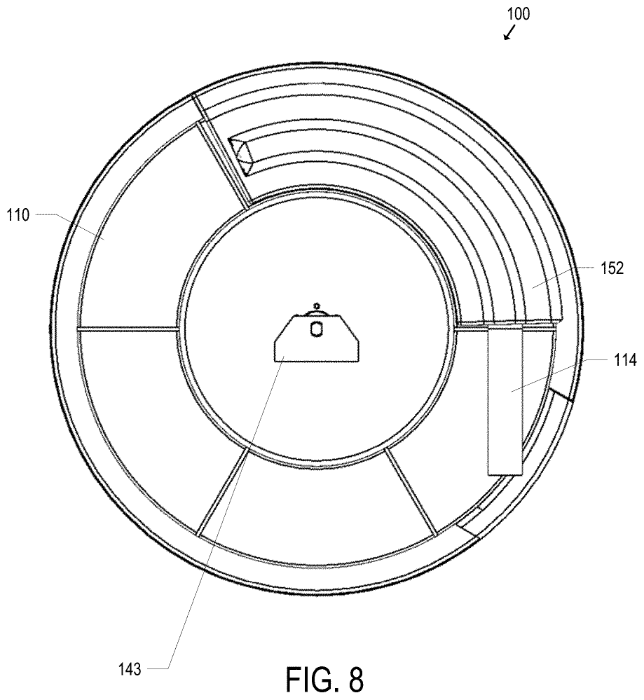

FIG. 7 shows a side view of the cable reel 100 without showing the full length of cable 114 and FIG. 8 shows the side view of the cable reel 100 without showing the full length of the cable 114 and without showing the hanger 105. The views of FIGS. 7 and 8 show the rotational side 110 of the cable reel 100. The rotational side 110 of the cable reel 100 includes a breakaway connector 152. The breakaway connector 152 is designed such that the cable 114 disconnects from the cable reel 100 upon a predetermined load being reached (e.g., if the cable 114 is connected to a vehicle when the vehicle drives away).

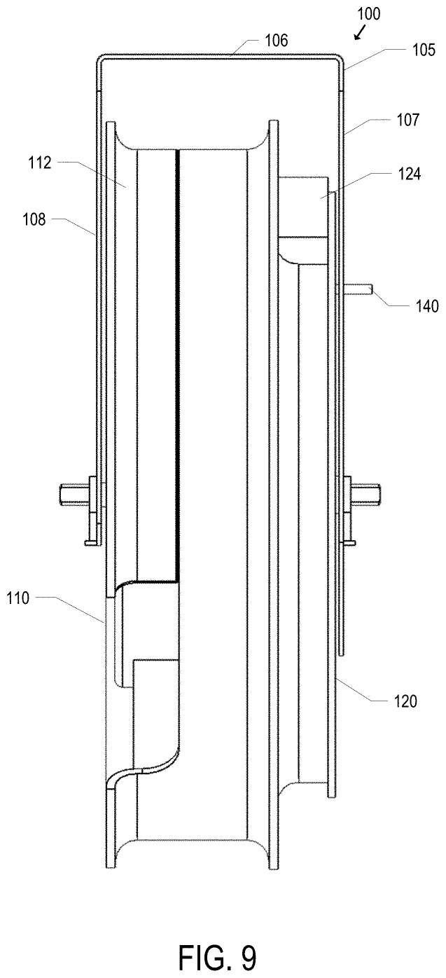

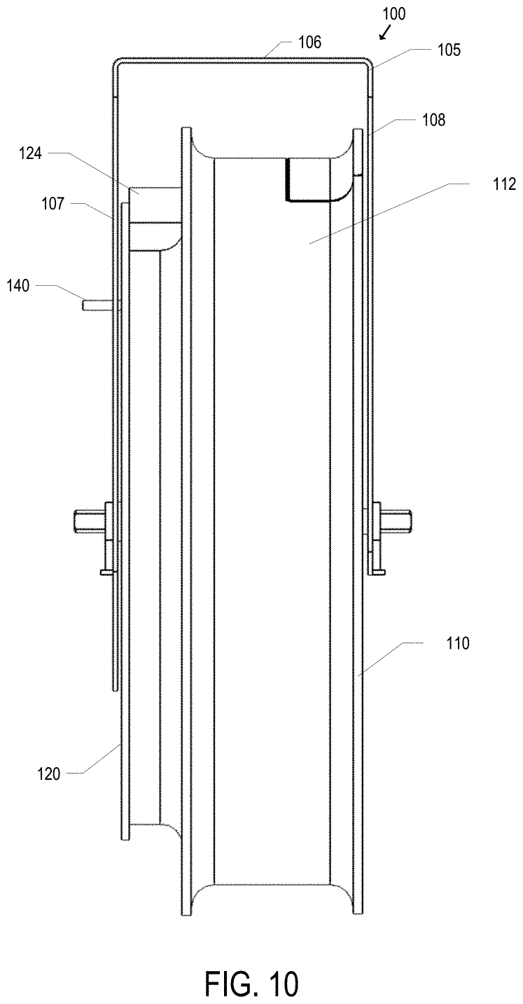

FIG. 9 shows a front view of the cable reel 100 without showing the cable 114 or the cable 122 and FIG. 10 shows a rear view of the cable reel 100 without showing the cable 114 or the cable 122.

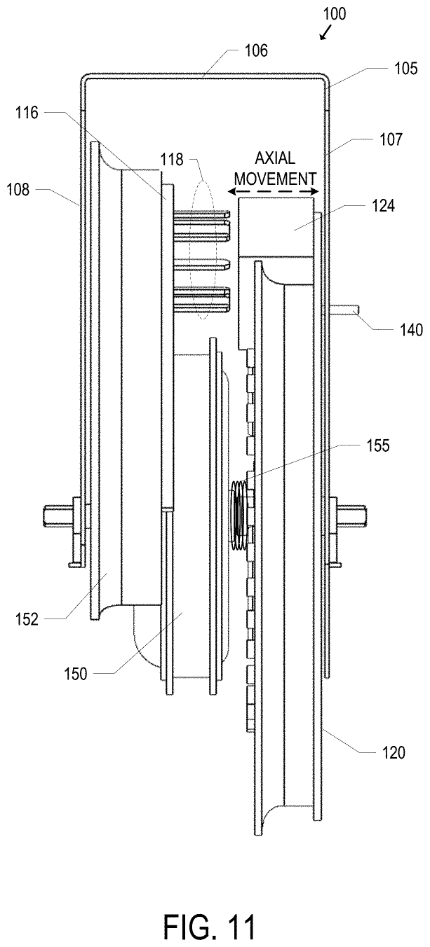

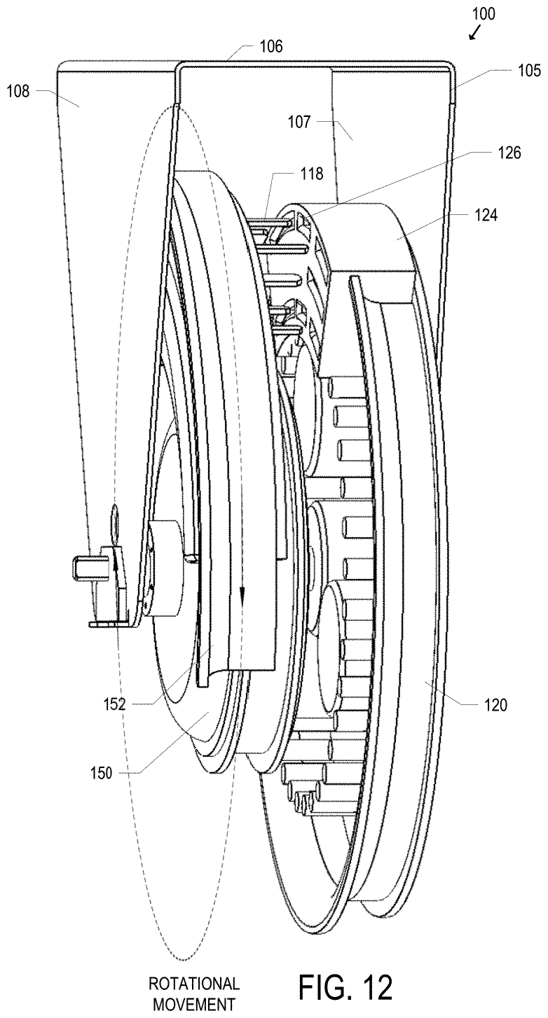

FIG. 11 shows a front view of the cable reel 100 without showing the spool 112, the cable 114, and the cable 122, and FIG. 12 shows a front perspective view of the cable reel 100 showing the same. The motor 150 controls or assists in winding and/or unwinding the cable 114. For example, the cable 114 is feed out and retracted by the motor 150. The motor 150 is a motor (e.g., a back-drivable DC hub motor, an AC motor, a stepper motor, a brushed motor, a brushless motor, a hydraulic motor, a pneumatic motor, a linear motor, etc.). The motor 150 may include an encoder that can be used for determining the current position of the spool 112 (e.g., the number of revolutions) and therefore the length of cable 114 that is extended from the spool 112 at a given time. Instead of an integrated encoder, an external encoder (e.g., a quadrature encoder) or sensor (e.g., an optical sensor) may be used to determine the current position of the spool 112. The motor 150 may receive its power from a power source that is separate from the cable 114 and the non-rotating cable 122. Although not illustrated in the Figures, in an embodiment the cable reel 100 includes a software controlled control board that receives the spool position data (e.g., from the encoder or sensor) and controls the solenoids 146A-C such as energizing the solenoids 146A-C (e.g., causing a current to be applied to the solenoids 146A-C) to cause the solenoid plungers 148A-C to extend and/or retract.

The motor 150 may be controlled in different ways in different embodiments. In an embodiment, a controller that is physically or wirelessly connected to the cable reel 100 controls the motor 150 including causing it to wind and/or unwind the cable 114. The controller may include one or more physical buttons or switches for winding and/or unwinding the cable 114. In another embodiment, the motor 150 is controlled through network communication (e.g., a processor included in the cable reel 100 may receive and process a command to wind, unwind, and/or stop the winding/unwinding of the cable 114). The network communication may be received through a personal area network (e.g., Bluetooth, Zigbee), local area network, or a wide area network. By way of example, an application on a mobile device (e.g., a smartphone, a tablet, etc.) or a web application available on the internet may receive input to wind, unwind, and/or stop the winding/unwinding of the cable 114 and a corresponding command may be sent to the processor included in the cable reel 100. In another embodiment, a camera or other detector may detect an object (e.g., an electric vehicle, a hand gesture) and automatically start extending the cable.

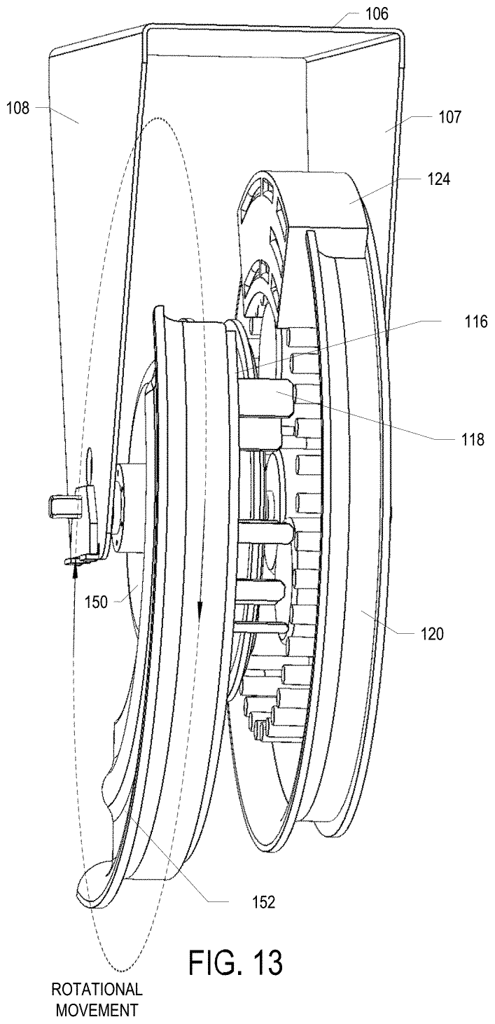

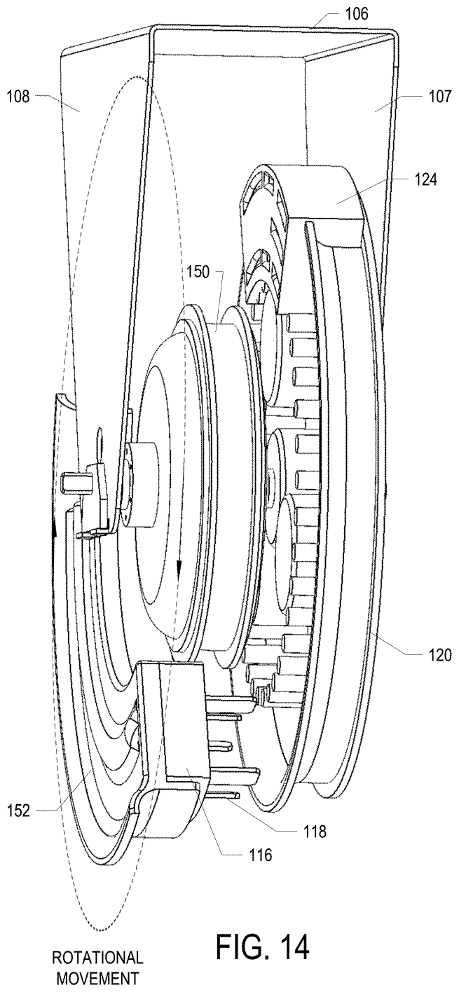

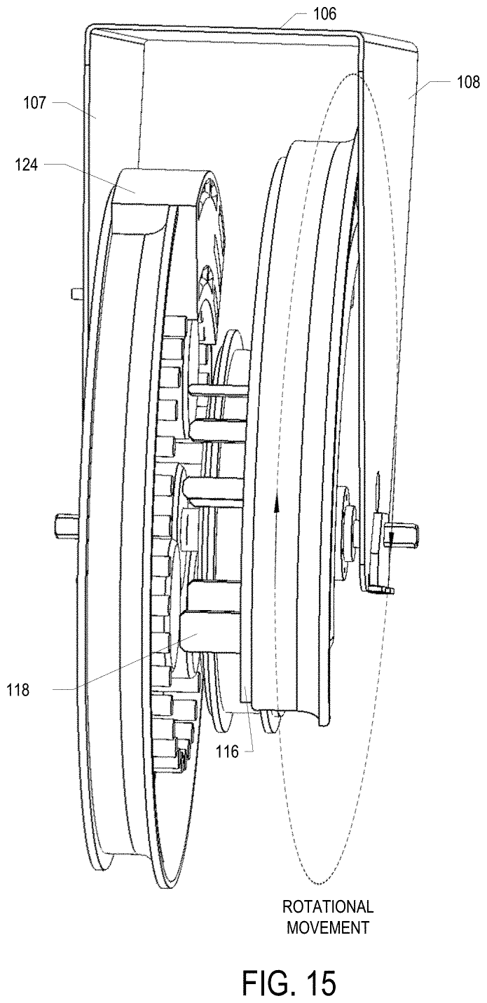

The rotating connector 116 is fixed to the spool 112 and rotates in relation to the spool 112. The rotating connector 116 may be axially fixed (i.e., it may not move axially). As shown in FIG. 11, the rotating connector 116 is positioned substantially on the edge of the spool 112. In other embodiments, the rotating connector 116 is axially located in relation to the spool 112. As the spool 112 rotates (e.g., the cable 114 is being extended or unwound from the spool 112 by the motor 150), the rotating connector 116 also rotates around the axis of the spool 112. For example, assuming that the rotating connector 116 starts in the position as shown in FIG. 12 when the cable 114 is fully wound around the spool, FIGS. 13-15 show the rotating connector 116 in different positions as it rotates relative to the spool 112. FIG. 13 shows a front perspective of the cable reel 100 like FIG. 12 that shows the position of the rotating connector 116 when the spool 112 has completed approximately one-quarter of a full revolution. FIG. 14 shows a front perspective of the cable reel 100 like FIG. 12 that shows the position of the rotating connector 116 when the spool 112 has completed approximately one-half of a full revolution. FIG. 15 shows a rear perspective of the cable reel 100 that shows the position of the rotating connector 116 when the spool 112 has completed approximately three-quarter of a full revolution. As sheen in FIGS. 13-15, the rotating connector 116 is not aligned with the rotationally fixed connector 124. Going back to FIG. 12, the rotating connector 116 returns to its starting position when the spool 112 has completed a full revolution and is aligned with the rotationally fixed connector 124. The rotationally fixed connector 124 does not rotate as shown in FIGS. 13-15. Although FIGS. 13-15 show the rotational movement for extending (unwinding) the cable 114, the spool 112 is rotatable is rotatable in the opposite direction for retracting (winding) the cable 114 and the rotating connector 116 would rotate accordingly in relation to the spool 112.

The rotating connector 116 includes multiple pin contacts 118 that mate with corresponding pin receptacle contacts 126 of the rotationally fixed connector 124. The pin contacts 118 may be blade-like lugs and the pin receptacle contacts 126 may be spring fingers. However, alternative connector types may be used such as sleeve/barrel connectors, bolted lugs, etc. Also, the rotating connector 116 can have female contacts and the rotationally fixed connector 124 can have male contacts. Although multiple pin contacts 118 and multiple pin receptacle contacts 126 are shown, in some implementations a single contact and receptacle may be used.

As shown in FIGS. 11 and 12, the rotating connector 116 is not mated with the rotationally fixed connector 124 but is aligned with the rotationally fixed connector 124. In an embodiment, the rotating connector 116 will not mate with the rotationally fixed connector 124 when the spool 112 is rotating or when the cable 114 is wound around the spool 112. For example, if the cable 114 is in the position as shown in FIGS. 1 and 2, the rotating connector 116 will not be mated with the rotationally fixed connector 124 and thus no electrical connection will exist between the cable 114 and the non-rotating cable 122. Thus, as shown in FIGS. 11 and 12, the rotationally fixed connector 124 is in a first position (an unmated position) when unmated with the rotating connector 116.

As previously described, in an embodiment the conductor(s) of the cable 114 and the conductor(s) of the non-rotating cable 122 are not electrically connected when the cable 114 is wound around the spool 112 or when the spool 112 is rotating. Instead, the conductor(s) of the cable 114 and the conductor(s) of the non-rotating cable 122 may electrically connect when the rotating connector 116 and the rotationally fixed connector 124 are in a predetermined position (e.g., they are aligned) and at least some of the cable 114 has been extended from the cable reel 100. In an embodiment, the solenoids 146A-C cause the rotationally fixed connector 124 to axially move to mate with the rotating connector 116.

In an embodiment, upon a predetermined length of cable 114 being extended as determined by the position of the spool 112, the solenoids 146A-C are energized causing the solenoid plungers 148A-C respectively to extend. The spool position information, which as described above may be measured or detected using an encoder or other sensor, is sent to a control board. Software on the control board uses the spool position information to determines if the predetermined length of cable 114 has been extended. The software then controls the solenoids 146A-C (e.g., causes the control board to energize the solenoids 146A-C) to cause the solenoid plungers 148A-C to extend. The predetermined length of cable is chosen such that the rotating connector 116 will be mateably aligned with the rotationally fixed connector 124. Since the rotating connector 116 rotates in relation to the spool 112, the rotating connector 116 will be in the same position as its initial position upon one complete full revolution of the spool 112. The predetermined length of cable may correspond to one or more full revolutions of the spool 112. In a specific embodiment, the predetermined length of cable corresponds to the complete payout of the cable 114.

The extension of the solenoid plungers 148A-C causes axial movement of the rotationally fixed side 120 towards the rotational side 110 to mate the rotating connector 116 and the rotationally fixed connector 124. The solenoid plungers 148A-C extend and push against the side of the hanger 105 causing the rotationally fixed side 120, including the rotationally fixed connector 124, to axially move towards the rotational side 110 and compress the spring 155. The spring 155 may be a compression spring. This axial movement causes the rotating connector 116 and the rotationally fixed connector 124 to mate.

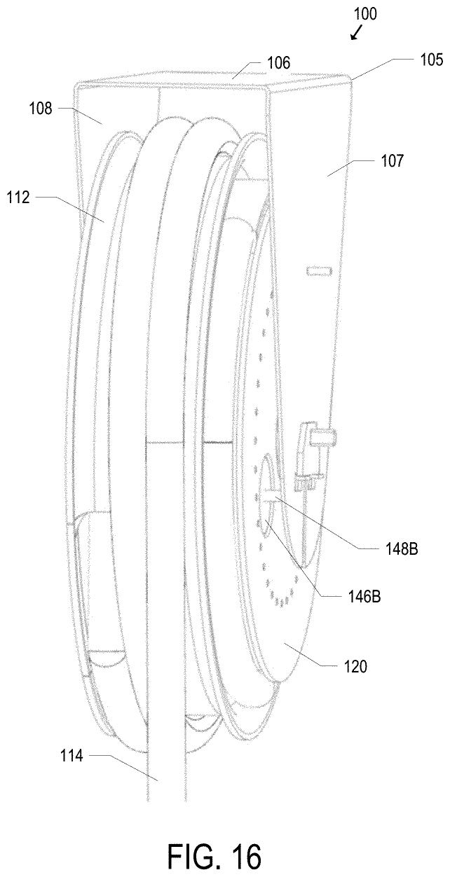

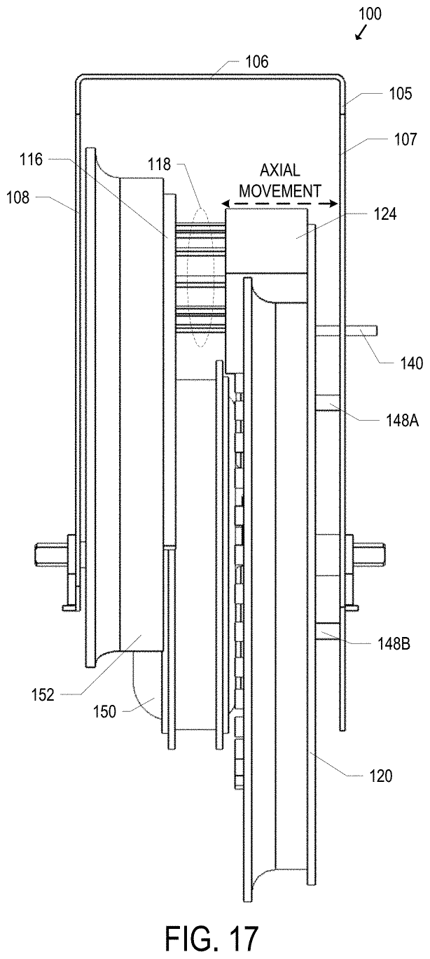

FIG. 16 illustrates the cable reel 100 where the solenoid plungers 148A-C are extended. FIG. 17 shows a front view of the cable reel 100 without showing the spool 112, the cable 114, and the cable 122, where the solenoid plungers 148A-C are extended. As shown in FIG. 17, the solenoid plungers 148A and 148B push against the side member 107 of the hanger 105 (the solenoid plunger 148C also pushes against the side member 107 of the hanger 105 but it is not visible in the view of FIG. 17). This causes the rotationally fixed side 120 to axially move toward the rotational side 110 and the rotationally fixed connector 124 to mate with the rotating connector 116. Thus, the rotationally fixed connector 124 has axially moved to a second position (a mated position) when mated with the rotating connector 116. As shown in FIG. 17, the pin contacts 118 of the rotating connector 116 are mated with corresponding pin receptacle contacts of the rotationally fixed connector 124. When mated, the conductor(s) of the cable 114 and the conductor(s) of the non-rotating cable 122 are electrically connected.

When the solenoid plungers 148A-C retract (e.g., energized in the case the solenoids 146A-C are latching solenoids), the spring 155 decompresses causing the rotationally fixed side 120, including the rotationally fixed connector 124, to axially move away from the rotational side 110 thereby unmating the rotating connector 116 and the rotationally fixed connector 124. The solenoids 146A-C may cause the solenoid plungers 148A-C to retract in response to a command being received to wind (retract) the cable 114 (e.g., through a controller, through network communication, etc.). The control board may receive the command and software on the control board may then control the solenoids 146A-C to retract the solenoid plungers 148A-C (e.g., in the case of latching solenoids, energize the solenoids 146A-C to retract the solenoid plungers 148A-C).

In an embodiment where the cable reel 100 is used to wind/unwind a cable for charging electric vehicles, the depression of the connector latch on the electric vehicle connector and/or the removal of the electric vehicle connector from the electric vehicle inlet may cause the solenoid plungers 148A-C to retract (causing the rotating connector 116 and the rotationally fixed connector 124 to unmate) and/or may cause the motor 150 to automatically retract the cable 114. Thus, when the cable is beginning to retract or just prior to the cable beginning to retract, the rotating connector 116 and the rotationally fixed connector 124 automatically unmate.

In an embodiment, the rotating connector 116 is aligned with the rotationally fixed connector 124 when the full length of the cable 114 has been extended from the spool 112 (a complete payout of the cable 114). For instance, if it takes three full revolutions of the spool 112 to fully payout the cable 114, the rotating connector 116 will be aligned with the rotationally fixed connector 124 when three full revolutions of the spool 112 have been made. In this example, the rotating connector 116 will also be aligned with the rotationally fixed connector 124 at the first full revolution and the second full revolution of the spool 112. In an embodiment, the solenoid plungers 148A-C are extended only responsive to complete payout of the cable 114. In this example, the solenoids 146A-C are energized causing the solenoid plungers 148A-C to extend thereby causing the rotating connector 116 and the rotationally fixed connector 124 to mate only when three full revolutions of the spool 112 have been made.

In another embodiment, the solenoid plungers 148A-C are extended thereby causing the rotating connector 116 and the rotationally fixed connector 124 to mate each time the connectors are aligned (e.g., at each full revolution). An encoder, optical sensor, or other sensor may be included in the cable reel 100 or the motor 150 to determine the position of the spool 112 and therefore when the rotating connector 116 is aligned with the rotationally fixed connector 124, which triggers the control board to control the solenoids 146A-C to cause the solenoid plungers 148A-C to extend. As the spool 112 keeps rotating, the solenoid plungers 148A-C are retracted thereby causing the rotating connector 116 and the rotationally fixed connector 124 to unmate.

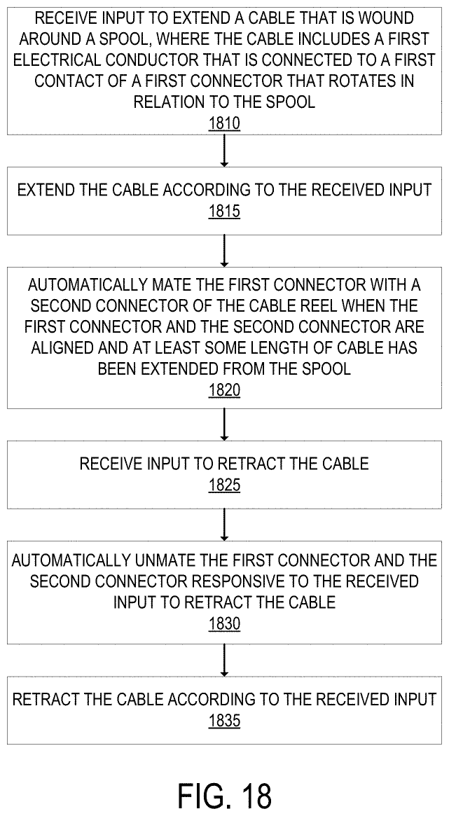

FIG. 18 is a flow diagram that illustrates exemplary operations for the cable reel described herein according to an embodiment. The operations of FIG. 18 will be described relative to the embodiments of the other Figures. However, the operations of FIG. 18 can be performed by embodiments other than those of the other figures, and the embodiments of the other figures can perform operations different than those of FIG. 18.

At operation 1810, a cable reel (e.g., the cable reel 100) receives input to extend (unwind) a cable that is wound around a spool of the cable reel. The cable includes a first electrical conductor that is connected to a first contact of a first connector. The first connector rotates in relation to the spool (e.g., the rotating connector 116). The input to extend the cable may be received in different ways in different embodiments. In one embodiment, the input is received through a controller that is physically or wirelessly connected to the cable reel that controls a motor of the cable reel (e.g., the motor 150), where the controller includes one or more buttons or switches to unwind and/or wind the cable. In another embodiment, the input is received through network communication (e.g., a processor included in the cable reel may receive and process a command to wind, unwind, and/or stop the winding/unwinding of the cable). The network communication may be received through a personal area network (e.g., Bluetooth, Zigbee), local area network, or a wide area network. By way of example, an application on a mobile device (e.g., a smartphone, a tablet, etc.) or a web application available on the internet may receive input to wind, unwind, and/or stop the winding/unwinding of the cable and a corresponding command may be sent to the processor included in the cable reel. In another embodiment, a camera or other detector may detect an object (e.g., an electric vehicle, a hand gesture) and automatically transmit input to the cable reel to extend the cable. The received input may indicate how much cable to extend. In an embodiment, the input is manually received as a result of an operator pulling the cable when it is on the spool.

Next, at operation 1815, the cable reel extends the cable according to the received input. For example, the cable reel rotates the spool to unwind the cable. A motor of the cable reel may control or assist in rotating the spool. While the spool is rotating, the first connector is not mated with a second connector that is on the non-rotating side of the cable reel. In an embodiment, the cable reel is designed to extend the cable until a predetermined length of the cable has been extended from the cable reel. The predetermined length may be chosen such that the first connector and the second connector are aligned in a mateable position. The predetermined length may be a complete payout of the cable.

Next, at operation 1820, the cable reel automatically mates the first connector with a second connector of the cable reel when the first connector and the second connector are aligned and at least some length of cable has been extended from the spool. An electrical connection is made when the first connector and the second connector are mated between the first electrical conductor of the cable and a second electrical conductor that is connected to a second contact of the second connector. Automatically mating the first connector with the second connector may include causing the second connector, which is rotationally fixed, to axially move to mate with the first connector. An encoder, optical sensor, or other sensor may be used to determine the position of the spool. The position information may be used by a software controlled control board to determine when the first connector and the second connector are aligned and control the solenoid to cause a solenoid plunger to extend and push against a side member of the cable reel causing the second connector to axially move and mate with the first connector and may cause a spring to compress. The solenoid may be controlled when the motor is finished rotating the spool.

Next, at operation 1825, the cable reel receives input to retract (wind) the cable. The input to retract (wind) the cable may be received in a similar way as the input to extend (unwind) the cable.

Next, at operation 1830, the cable reel automatically causes an unmating of the first connector with the second connector responsive to the received input to retract the cable. This breaks the electrical connection between the first electrical conductor of the cable with the second electrical conductor that is connected to the second contact of the second connector. Automatically unmating the first connector and the second connector may include causing the second connector, which is rotationally fixed, to axially move away from the first connector which unmates the two connectors. The control board may receive the input to retract the cable that triggers it to control the solenoid to retract the solenoid plunger to cause the spring to decompress causing the second connector to axially move away from the first connector.

Next, at operation 1835, the cable reel retracts (winds) the cable according to the received input. For instance, the spool of the cable reel rotates in the opposite direction to retract the cable. A motor of the cable reel may control or assist in rotating the spool. While the spool is rotating, the first connector is not mated with a second connector that is on the non-rotating side of the cable reel. In an embodiment, the cable reel is designed to fully retract the cable.

As described above, the cable reel 100 may be used in connection with an EVSE. In such a use, the cable 114 may be a charging cable for charging an electric vehicle. The charging cable may include one or more power wires that carry power between the EVSE and an electric vehicle, a ground wire, and one or more data wires (signal wires) such as a control pilot signal wire and a proximity detection signal wire. When the rotating connector 116 and the rotationally fixed connector 124 are mated, power and data can be carried between the EVSE and the electric vehicle. The EVSE can include one or more of a controller, a power control device, network communication module(s), and communication circuitry. The power control device includes circuitry for electrically connecting a power source and the electric vehicle to allow or prevent energy from being transferred between the power source and the electric vehicle. For example, the power control device may include a set of one or more contactors or other devices on one or more power lines for turning on or off charge transfer between the electric vehicle and the EVSE. The power control device may include circuitry to variably control the amount of power draw (e.g., Pulse Width Modulation (PWM) circuitry). The power control device may be under control of the controller to energize or de-energize as appropriate. The controller includes a processor and a memory (e.g., a non-transitory machine-readable storage medium) and provides for central control over the EVSE. For instance, the controller manages the power control device such as causing the contactor(s) to open and close as appropriate. The controller may also include and execute an operating system for the EVSE. The operating system manages certain hardware and software for the EVSE including one or more of: a set of one or more network communication modules to communicate with a network (e.g., a Wide Area Network (WAN) module and/or a Local Area Network (LAN) module to communicate with a WAN and/or LAN network); a display module to manage a display of the EVSE; a Radio Frequency Identification (RFID) module for managing an RFID transceiver.

### Alternative Embodiments

Although an embodiment has been described that shows the rotationally fixed connector 124 axially moving to mate with the rotating connector 116, which is axially fixed, in an alternative embodiment the rotating connector also axially moves to mate with the rotationally fixed connector. In such an embodiment, the rotationally fixed connector is also axially fixed.

Although the figures show one rotating connector that rotates in relation to the spool, in an alternative embodiment there are multiple rotating connectors that are each connected to the cable 114 that rotate in relation to the spool. This embodiment allows there to be multiple places where the spool can stop rotating and the rotationally fixed connector and the rotating connector can mate.

Embodiments have been described that show the rotating connector 116 rotating around the edge of the spool 112. In other embodiments, the rotating connector 116 is centrally located related to the spool 112 (rotating around the axis of the spool 112) and the rotationally fixed connector 124 is also centrally located. In such embodiments, the rotating connector 116 may be aligned with the rotationally fixed connector 124 more frequently compared to if the rotating connector 116 is located at the edge of the spool 112.

While embodiments have described the use of a motor to wind/unwind the cable, other embodiments use as manual crank/wheel, pull cable/chain, or gravity fed way of winding/unwinding the cable.

Embodiments have been described that use one or more solenoids to cause the rotating connector and the rotationally fixed connector to mate. In other embodiments, the rotating connector and the rotationally fixed connector are mated differently (e.g., through the use of levers, cams, pneumatic actuator, hydraulic actuator, or other linear actuator).

Embodiments have been described that axially move the rotationally fixed side 120 in its entirety including the rotationally fixed connector 124 to mate the rotating connector 116 and the rotationally fixed connector 124. In another embodiment, only the rotationally fixed connector 124 is axially moved to mate with the rotating connector 116. In such an embodiment, a linear actuator may cause the rotationally fixed connector 124 to move to mate with the rotating connector 116.

Although FIGS. 1-17 show the cable reel in a vertical orientation, the cable reel described herein may also be used in a horizontal orientation.

The techniques shown in the figures may be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the preceding description, numerous specific details such types and interrelationships of system components are set forth in order to provide a more thorough understanding. It will be appreciated, however, by one skilled in the art that embodiments may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A cable reel, comprising:
a spool that rotates to extend and retract a cable, wherein the cable includes a first electrical conductor;
a first connector that is connected with the spool and rotates in relation to the spool, wherein the first connector includes a first contact that is connected to the first electrical conductor of the cable; and
a second connector that does not rotate, wherein the first connector and the second connector are mateable, wherein the second connector includes a second contact that is connected to a second electrical conductor, wherein the first connector and the second connector automatically mate to make an electrical connection between the first electrical conductor of the cable and the second electrical conductor when the first connector and the second connector are aligned in a predetermined position and at least some length of cable has been extended, and wherein the first connector and the second connector automatically unmate to break the electrical connection between the first electrical conductor of the cable and the second electrical conductor when the cable is retracted.

2. The cable reel of claim 1, wherein the at least some length of cable has been extended is a fully extended cable.

3. The cable reel of claim 1, wherein the second connector is at a first position when unmated with the first connector and moves axially to a second position when mated with the first connector.

4. The cable reel of claim 1, wherein the first connector is axially fixed.

5. The cable reel of claim 1, further comprising:
a solenoid to cause the second connector to mate with the first connector when the at least some length of cable has been extended.

6. The cable reel of claim 1, further comprising:
a motor to extend and retract the cable.

7. The cable reel of claim 1, further comprising:
a side member that is made of rigid material; and
a control board to cause current to be applied to a solenoid to cause a plunger of the solenoid to extend and push against the side member causing the second connector to axially move and mate with the first connector and causing a spring to be compressed, and to cause current to be applied to the solenoid to cause the plunger of the solenoid to retract causing the spring to decompress causing the second connector to axially move away from the first connector and unmate with the first connector.

8. The cable reel of claim 1, wherein the first connector is axially located in relation to the spool.

9. The cable reel of claim 1, wherein the first connector is located substantially on an edge of the spool.

10. The cable reel of claim 1, wherein the cable is a charging cable for charging an electric vehicle.

11. A method, comprising:
receiving input to extend a cable that is wound around a spool of a cable reel, wherein the cable includes a first electrical conductor that is connected to a first contact of a first connector, wherein the first connector rotates in relation to the spool;
extending the cable according to the received input;
automatically causing a mating of the first connector with a second connector of the cable reel when the first connector and the second connector are aligned in a predetermined position and at least some length of cable has been extended from the spool, wherein the second connector is rotationally fixed, and wherein mating of the first connector and the second connector makes an electrical connection between the first electrical conductor of the cable with a second electrical conductor that is connected to a second contact of the second connector;
receiving input to retract the cable;
automatically causing an unmating of the first connector with the second connector to break the electrical connection responsive to the received input to retract the cable; and
retracting the cable according to the received input.

12. The method of claim 11, wherein the at least some length of cable has been extended is a fully extended cable.

13. The method of claim 11, wherein automatically causing the mating of the first connector with the second connector includes causing the second connector to axially move to mate with the first connector.

14. The method of claim 11, wherein the first connector is axially fixed.

15. The method of claim 11, wherein automatically causing the mating of the first connector with the second connector includes applying current to a solenoid to cause the second connector to mate with the first connector.

16. The method of claim 11, wherein a motor extends the cable according to the received input, and wherein the motor retracts the cable according to the received input.

17. The method of claim 11, wherein automatically causing the mating of the first connector with the second connector includes applying current to a solenoid to cause a plunger of the solenoid to extend and push against a side member of the cable reel causing the second connector to axially move and mate with the first connector and causing a spring to compress, wherein automatically causing the unmating of the first connector with the second connector includes applying current to the solenoid to cause the plunger of the solenoid to retract causing the spring to decompress causing the second connector to axially move away from the first connector and unmate with the first connector.

18. The method of claim 11, wherein the first connector is axially located in relation to the spool.

19. The method of claim 11, wherein the first connector is located substantially on an edge of the spool.

20. The method of claim 11, wherein the cable is a charging cable for charging an electric vehicle.

21. A system, comprising:
an electric vehicle supply equipment (EVSE); and
a cable reel including:
a spool that rotates to extend and retract a cable, wherein the cable is for charging an electric vehicle and includes a first electrical conductor,
a first connector that is connected with the spool and rotates in relation to the spool, wherein the first connector includes a first contact that is connected to the first electrical conductor of the cable; and
a second connector that does not rotate, wherein the first connector and the second connector are mateable, wherein the second connector includes a second contact that is connected to a second electrical conductor that terminates at the EVSE, wherein the first connector and the second connector automatically mate to make an electrical connection between the first electrical conductor of the cable and the second electrical conductor when the first connector and the second connector are aligned in a predetermined position and at least some length of cable has been extended, and wherein the first connector and the second connector automatically unmate to break the electrical connection between the first electrical conductor of the cable and the second electrical conductor when the cable is retracted.

22. The system of claim 21, wherein the at least some length of cable has been extended is a fully extended cable.

23. The system of claim 21, wherein the second connector is at a first position when unmated with the first connector and moves axially to a second position when mated with the first connector.

24. The system of claim 21, wherein the first connector is axially fixed.

25. The system of claim 21, wherein the cable reel further includes a solenoid to cause the second connector to mate with the first connector when the at least some length of cable has been extended.

26. The system of claim 21, wherein the cable reel further includes a motor to extend and retract the cable.

27. The system of claim 21, wherein the cable reel further includes:
a side member that is made of rigid material; and
a control board to cause current to be applied to a solenoid to cause a plunger of the solenoid to extend and push against the side member causing the second connector to axially move and mate with the first connector and causing a spring to be compressed, and to cause current to be applied to the solenoid to cause the plunger of the solenoid to retract causing the spring to decompress causing the second connector to axially move away from the first connector and unmate with the first connector.

28. The system of claim 21, wherein the first connector is axially located in relation to the spool.

29. The system of claim 21, wherein the first connector is located substantially on an edge of the spool.
